(19) United States
(12) Patent Application Publication
(10) Pub. No.: US 2017/0308957 A1
(43) Pub. Date: Oct. 26, 2017

(54) METHODS AND SYSTEMS FOR COMPETITIVE BIDDING AND VERIFICATION OF YIELD RESTRICTED ESCROWS AND INVESTMENTS

(71) Applicant: Robert Joe White, Prosper, TX (US)

(72) Inventor: Robert Joe White, Prosper, TX (US)

(21) Appl. No.: 15/493,966

(22) Filed: Apr. 21, 2017

Related U.S. Application Data
(60) Provisional application No. 62/326,276, filed on Apr. 22, 2016.

(51) Int. Cl. G06Q 40/06; G06Q 30/08; G06Q 40/02

(52) U.S. Cl. CPC G06Q 40/06; G06Q 30/08; G06Q 40/02

(57) ABSTRACT

Systems and methods for conducting business using competitive bidding and verification of yield restricted escrows and investments are disclosed. The methods can include automatically transmitting a request for proposal (RFP) from an issuer to at least a predetermined minimum number of potential bidders. According to certain embodiments, the RFP can include written bid specifications including an amount of money made available to be used to purchase one or more open market securities (OMS), a settlement date, proposal due date, a required cash flow, and an indication of OMS type eligibility. According to certain embodiments, the method can include automatically transmitting to the issuer a plurality of bids to provide one or more OMS to be purchased using the escrow amount in conformity with the written bid specifications, from at least a predetermined minimum number of bidders.

### CROSS-REFERENCE TO RELATED APPLICATIONS

This application claims the benefit, under 35 U.S.C. §119, of the filing date of Provisional Application No. 62/326,276 entitled “An Automated Platform to Provide a Method for Completing Competitive Bidding and Verification of Yield Restricted Escrows and Investments,” filed Apr. 22, 2016 by Robert Joe White, the contents of which are incorporated herein by reference in their entirety.

### TECHNICAL FIELD

The present disclosure relates to an automated system and method for conducting business using online competitive bidding and verification of yield restricted escrows and investments.

### BACKGROUND

Bonds are offered for sale in the municipal capital market in two different ways: negotiated and competitive sale. In a negotiated sale, an underwriting team is selected by the issuer of the bonds and its financial advisor negotiates for competitive market rates. In a competitive sale, a series of bonds is placed out for bid and the bonds are awarded to the purchaser who bids the lowest true interest cost or yield. When new bonds are sold for the purpose of refunding other, currently outstanding bonds, the proceeds of the new series of bonds after sale are placed in an escrow account solely dedicated to the payment of the previously-existing series of bonds that has now been “refunded”. The “life” of the escrow account depends on the repayment terms of the “refunded” series of bonds, but can range from one day to one or more years.

Tax-exempt bond proceeds held in such an escrow account must be either collateralized or (if they are to be held for more than 90 days) required to be invested until their use, but only in certain authorized securities and not at an investment return that exceeds the yield on the outstanding bonds that are being refunded. To accommodate these requirements, the financial advisor can either purchase State and Local Government Series (SLGS) securities directly from the U.S. Department of Treasury or obtain eligible securities on the open market from private financial institutions. Purchasing SLGS securities is the easier, but less efficient option, than obtaining eligible securities from private financial institutions which (i) interjects a degree of counterparty risk and (ii) requires that such a transaction be accomplished through a competitive process adhering to rules and regulations under applicable federal tax law concerning the investment of yield-restricted bond proceeds.

Conventionally, the competitive bond sale process is arduous for issuers and their financial advisors, requiring the use of either facsimile or email followed by subsequent telephonic verification of bid parameters. Online bidding platforms revolutionized this market and are now industry standard. The competitive process for obtaining eligible investments for escrow account funds has not followed suit and remains in a relatively primitive stage mirroring the initial stages of the competitive bid bond sale process.

There is a need for the bond market's automation for streamlining and modernizing processes relating to the investment of yield-restricted bond proceeds held in escrow funds. As a result of existing, antiquated processes, few financial institutions are even willing to participate in the escrow investment market segment. A modernized bidding method will facilitate greater efficiencies in transaction execution and, as seen in the competitive bond sale market, increase the number of bidding participants. These developments will act to provide additional investment earnings to issuers of refunding bonds, which saves them more money, results in the issuance of a lesser amount of tax-exempt bonds (which lowers the impact of tax-exempt borrowing on the U.S. Treasury), and provides an industry standard for municipal advisors that will encourage greater market participation.

### SUMMARY

Systems and methods are disclosed herein that relate to conducting business using competitive bidding and verification of yield restricted escrows and investments. The methods can include automatically transmitting a request for proposal (RFP) from an issuer to at least a predetermined minimum number of potential bidders. According to certain embodiments, the RFP can include written bid specifications including an amount of money made available to be used to purchase one or more open market securities (OMS), a settlement date, proposal due date, a required cash flow, and an indication of OMS type eligibility. According to certain embodiments, the method can include automatically transmitting to the issuer a plurality of bids to provide one or more OMS to be purchased using the escrow amount in conformity with the written bid specifications, from at least a predetermined minimum number of bidders.

Another embodiment is directed to a server configured to conduct business using competitive bidding and verification of the sufficiency for their intended purpose of yield restricted escrows and investments. The server includes a memory coupled to a processor, wherein the memory stores software, when executed by the processor, configured to receive an RFP from an issuer and automatically transmit the RFP to at least a predetermined minimum number of potential bidders. According to certain embodiments, the RFP includes written bid specifications including an amount of money made available to be used to purchase one or more open market securities (OMS), a settlement date, proposal due date, a required cash flow, and an indication of OMS type eligibility. The software is further configured to receive a plurality of bids to provide one or more OMS to be purchased using the escrow amount in conformity with the written bid specifications, from at least a predetermined minimum number of bidders, and automatically transmit to the issuer the plurality of bids.

According to various embodiments, the software can provide each bidder an input module in which each bidder can input information relating to respective sellable OMS, and automatically calculate a cash flow of one or more OMS selected by a bidder based on respective information of each OMS input by the bidder. The software can further automatically optimize the total purchase cost of all of the one or more OMS selected by the bidder, based on the respective calculated cash flows and their respective prices.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary system for conducting business using competitive bidding and verification of yield restricted escrows and investments according to an embodiment;

FIG. 2 illustrates a flowchart of an exemplary method of conducting business using competitive bidding and verification of yield restricted escrow and investments, according to an exemplary embodiment;

FIG. 3 shows an exemplary dashboard display which the issuer can select eligible securities, according to an exemplary embodiment;

FIG. 4 shows an exemplary dashboard display which shows various selected bid specifications, according to exemplary embodiments;

FIG. 5 shows an exemplary dashboard display for the bidder to enter securities information, according to an exemplary embodiment; and

FIG. 6 depicts an exemplary screenshot of auction results and a comparison between the optimized cost of OMS securities and SLGS securities, according to an exemplary embodiment.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

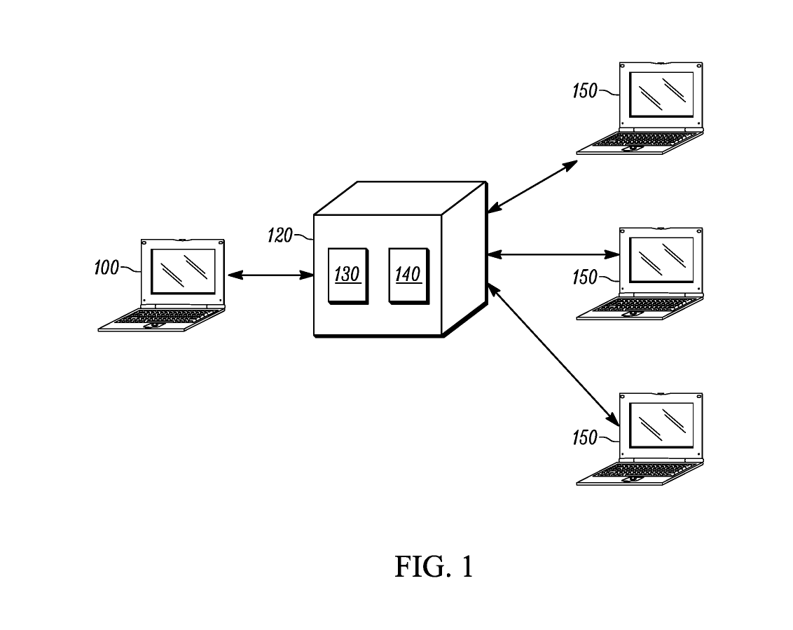

FIG. 1 illustrates an exemplary system including a computing environment according to one embodiment of the present disclosure. As shown in FIG. 1, the system can include at least one issuer user terminal 100 and terminals 150 of potential bidders. The software described herein can be executed by one or more processors communicatively coupled to memory, wherein any of the processors 130 and/or memory 140 may be located at a centralized server 120, according to one example (e.g., cloud computing), and/or within the end user terminals 100 and/or 150. Various functions described below may be performed at the server 120, which can be a remote, secure server or network of servers. Any of the terminals 100 and 150 can be a laptop computer or any other user terminal with a processor, memory, input/output devices and network connectivity allowing for wireless or wired communication with server 120.

Features of embodiments described herein are configured to be performed utilizing control system(s) that includes the one or more processors (e.g., CPUs, ASICs, FPGAs, and/or the like), memory, and a network interface. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present disclosure.

Systems disclosed herein are configured for conducting business using competitive bidding and verification of yield restricted escrows and investments. As will become apparent to one of ordinary skill in the art, the present disclosure describes methods for standardizing the competitive process for escrows, and providing the legal transparency the IRS has desired through the implementation of safe harbor regulations and approved documents.

### Refunding a Tax-Exempt Bond

Bonds are priced along a “yield curve” with longer maturities bearing interest at higher interest rates. In a traditional market, this yield curve rises over time. Tax-exempt bonds are “non-callable” (not pre-payable) prior to their maturity or early redemption date. The municipal bond market typically allows a 10-year optional redemption date at no cost at the time of issuance. As a bond's redemption or “call” date approaches, opportunity often arises to “refund” existing bonds with new bonds bearing interest at lower rates. Similar to refunding a mortgage where a new loan replaces the old, an issuer issues new bonds to pay off the old bonds. Because of interest rate sensitivity, refundings are often accomplished prior to an outstanding bond's call date, requiring that the refunding bonds' proceeds be escrowed until the call date of the refunded bonds.

### Escrow Fund

To prevent an issuer from having two series of bonds outstanding, an “escrow fund” is established. Proceeds from the refunding bond issuance are deposited to the escrow fund, which is pledged as security for the refunded bonds. State law may provide that a bond that is payable solely from the proceeds of an escrow fund is discharged and is no longer considered an outstanding obligation of the issuer (instead being payable only from the escrow fund and the amounts therein held). As a result, holders of “refunded” bonds can only look to the escrow fund for repayment.

The life of an escrow fund is determined by the duration between the issuance of refunding bonds and the call date of refunded bonds. Federal tax law makes legal distinction between an: “advance refunding escrow”, an escrow with a life of more than 90 days, and a “current refunding escrow”, one with a life of less than 90 days. Advance refunding escrows are subject to more restrictions (and subject to greater scrutiny) than current refunding escrows under federal tax law. An escrow is structured so proceeds are disbursed to the holders of refunded bonds on the scheduled debt service payments dates. At the call date, an escrow fund is liquidated and bondholders of refunded bonds are repaid in full.

### Arbitrage in a Tax-Exempt Bond Context

“Arbitrage” refers to the difference between what you pay in interest on tax-exempt bonds and what you earn from the investment of the proceeds of those bonds until their use. Local governments are prohibited from borrowing at subsidized, tax-exempt rates and investing those debt proceeds at rates above what they pay (yielding positive arbitrage). This concept is grounded in history, when local governments could invest debt proceeds in high-yielding investments.

### IRS Regulations Concerning Escrow Fund Investments

There may be two options for investing advance refunding escrow proceeds: purchase of “SLGS” securities directly from the federal government through the U.S Department of the Treasury; and purchase of “eligible securities” (as specified by state law or contracts entered into at the time of issuance of the refunded bonds) in the open markets. Escrows funded with SLGS securities are presumed compliant under federal tax law, but are often less “efficient” (i.e. lower investment return) or intermittently unavailable (due to federal gov′t reaching debt limit). Eligible escrow securities purchased on the open market (referred to as “open market securities” or “OMS”) must be acquired at “fair market value” for federal tax law compliance. Federal tax law, however, presumes that open market securities are NOT obtained at fair market value, but provides exceptions for refuting this presumption.

There may be four main parties involved in OMS processes described herein: financial advisor, bond counsel, bidding agent, and OMS provider(s). Some financial advisors act as their own bidding agent, while others rely on third party bidding agents. There are two main reasons that third party bidding agents are used: (1) bidding agents have the contacts that will bid on the eligible securities and (2) financial advisors want the escrow verified to the bid parameters and to make sure all safe harbor regulations are adhered to.

When bidding agents are involved, their fees range from $4,000 to $39,000 (with $39,000 being the current maximum amount (adjusted annually based on certain index factors) that may be charged without impact to the yield calculation). With the cost at this level and when the SLGS securities window is open, many financial advisors default to the use of SLGS securities instead of attempting an acquisition of OMS; unless the refunding amount is larger in size and advisors know OMS-funded escrows will prove to be significantly more advantageous economically even with the higher fees. Systems described herein could, for example, charge a flat fee for all transactions (e.g., $2,000). This will cut the lowest fees by 50% and provide bidders the ability to pass along additional savings to issuers. While the systems herein can eliminate the need for third party bidding agents, the lower fees will allow a place for bidding agents when advisors still require assistance.

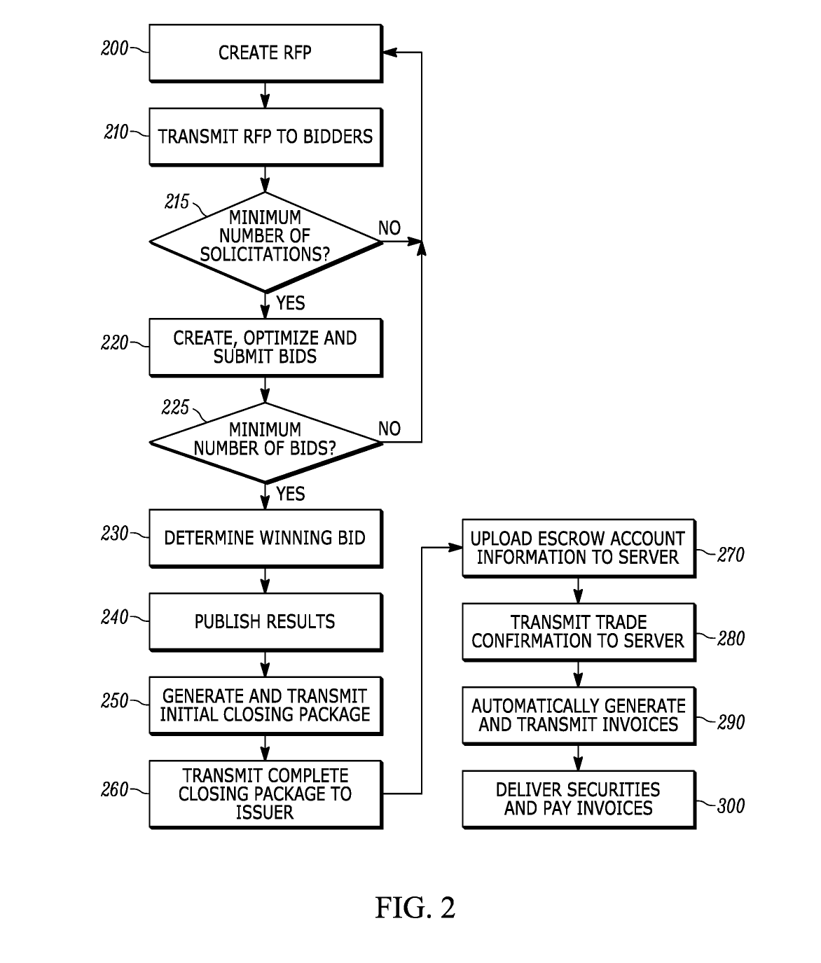

FIG. 2 provides an exemplary flowchart illustrating various functions of the present disclosure. Referring to FIG. 2, at step 200, an issuer (or a financial advisor/bidding agent) submits an RFP from user terminal 100 to server 120. When an issuer desires to create an RFP, software at server 120 can be executed to display a dashboard at terminal 100 for the issuer to enter bit specifications, including necessary contacts, dates, times and security eligibility, for example. The bid specifications can further include escrow requirements including escrow amounts and required cash flows. The RFP can further include a bidding agent fee and/or the fee for utilizing the software at server 120.

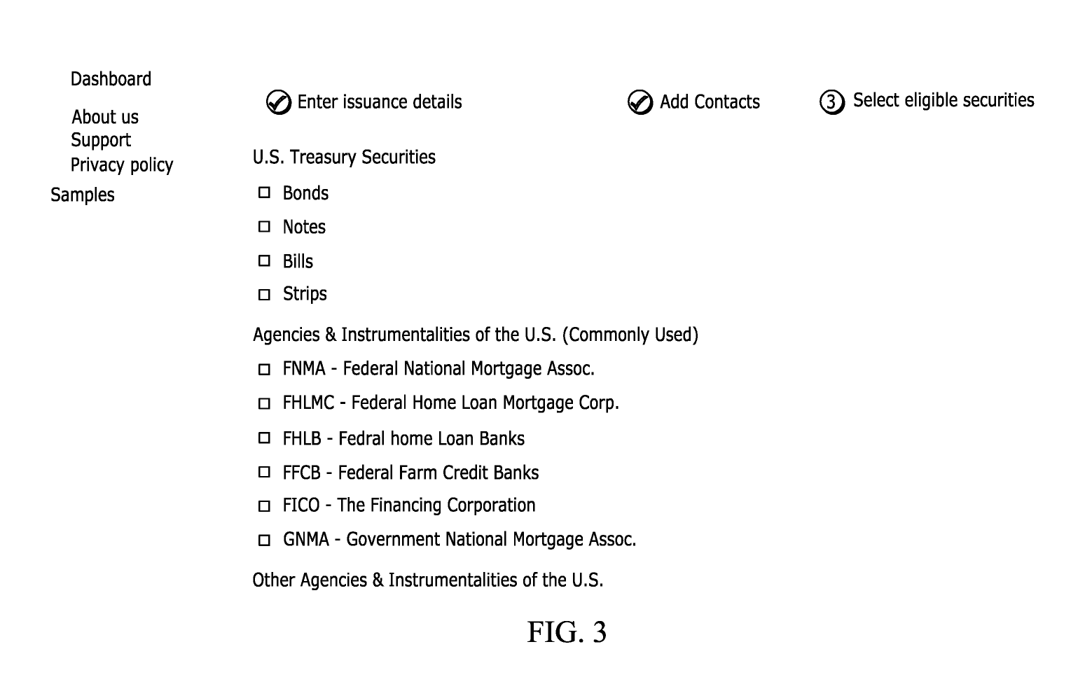

FIG. 3 shows an exemplary dashboard display which the issuer can select eligible securities by checking boxes on the screen indicating which types of OMS can purchased with the escrow amount. Of course, various layouts, selection mechanisms, and selectable securities can be implemented without departing from the scope of the present disclosure.

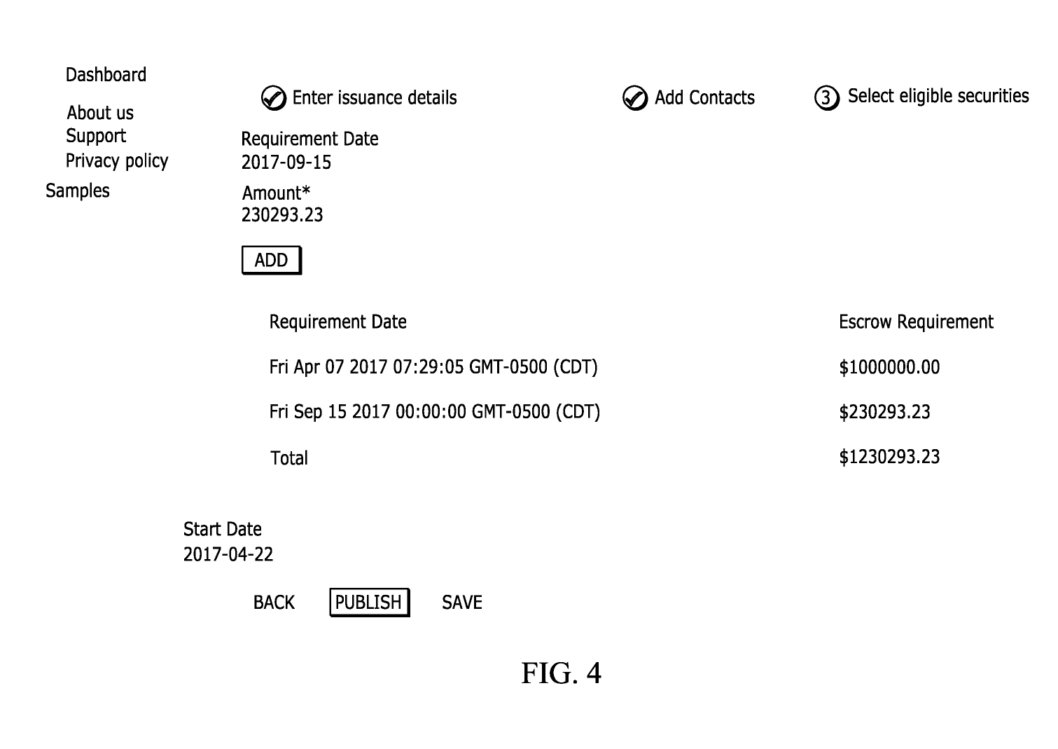

FIG. 4 shows an exemplary dashboard display which shows various selected bid specifications chosen by the issuer before soliciting bids. The exemplary bid specifications indicate escrow requirements and requirement dates. Once the issue reviews the bid specifications and presses the “PUBLISH” button, the server 120 will automatically transmit an indication that the RFP is available to potential bidders 150. The depicted exemplary screenshot is merely intended to show one possible display of bid specifications, and various other layouts or designs could be similarly utilized.

Referring back to FIG. 2, from step 200, the process moves to step 210, where the RFP is automatically transmitted as a notice of auction from server 120 to at least a minimum number of potential bidders (e.g., three bidders, according to one example) at terminals 150. Bidders can specify notification preferences to include an email of every auction upon upload, email every day with an upcoming auction summary, scheduled emails (e.g., weekly) providing a summary of upcoming auctions, or no notifications. In some embodiments, qualifying bidders can be preregistered with the server 120, and can be known OMS providers.

From step 210, the process proceeds to step 215, where the software at server 120 can determine which (if any) potential bidders have been sent the RFP and/or have opened the RFP for review. In the exemplary embodiment, if the SLGS window is closed, for example, the issuer must be able to show that at least three bids were solicited in order to accept a bid for OMS, in accordance with federal regulations. Thus, it is important for the solicitation information to be gathered and stored at server 120, for example, to prove that the eventual OMS purchase was at “fair market value.” If fewer than three bids were solicited (i.e., the RFP was sent to fewer than three potential bidders, or fewer than three potential bidders reviewed the RFP, then the process starts over and a new RFP can be created.

If at least three bids were solicited, from step 215, the process moves to step 220, where bidders create and submit bids to server 120 in response to the RFP. The software executed on server 120 is configured to display a dashboard on terminals 150 allowing the bidders to input bid information, including total escrow cost, specific securities, CUSIPs, amounts, prices, coupons, yields and dates. The bidders may also input the inventory of securities they have or that they can acquire, along with prices. Of course, it should be apparent to one of ordinary skill in the art that inputting information can be performed by various conventional mechanisms, including drag and drop, clicking options from a predetermined list of eligible securities determined by the RFP, or manually entering the information by typing in data fields.

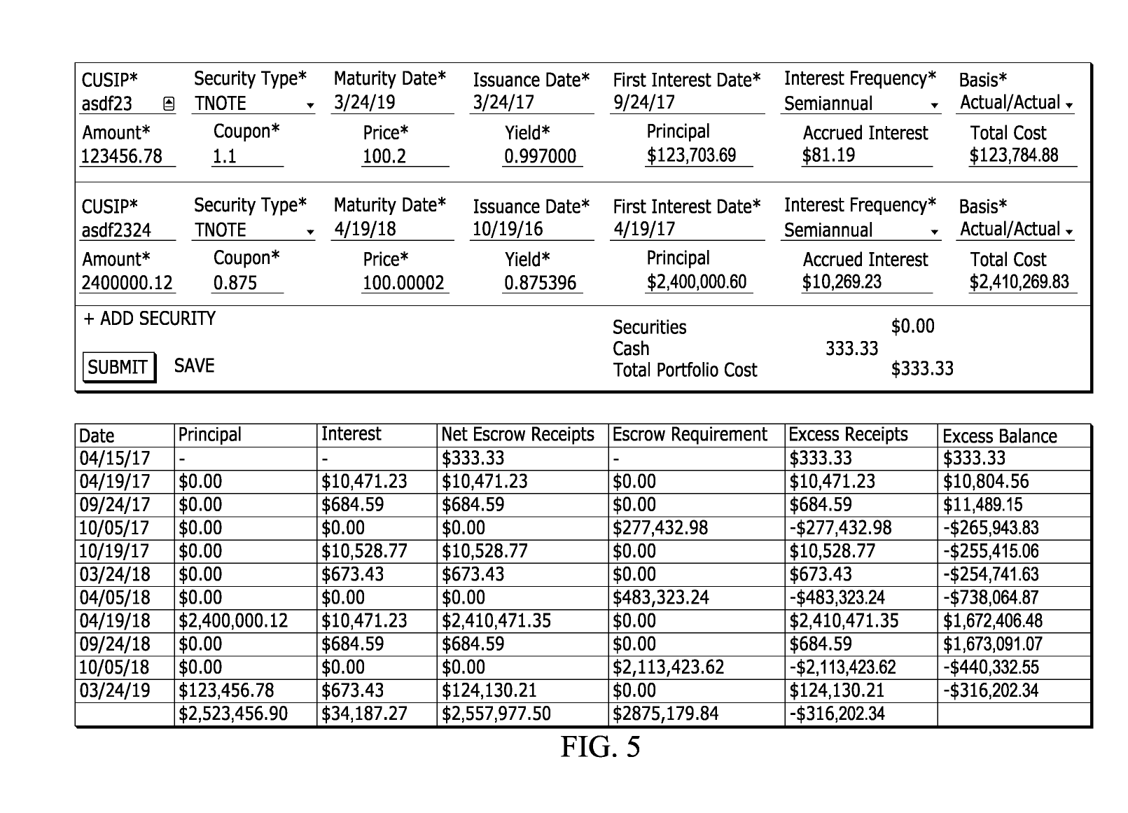

The software at server 120 optimizes the portfolio based on the available securities indicated by the bidders. For example, an algorithm can be executed to automatically calculate a cash flow of the OMS selected by a bidder based on a respective information of each OMS input by the bidder, and automatically optimize the total purchase cost of all of the OMS selected by the bidder, based on the respective calculated cash flows and their respective prices. FIG. 5 shows an exemplary dashboard screenshot displayed to the bidder, in which the bidder can enter various information of an available or obtainable OMS. As discussed below, the software at server 120, for example, can calculate cash flows and total price of the OMS based on certain information entered by the bidder.

### Cash Flow Calculator

The software can automatically calculate cash flow of each OMS by computing simple interest, based on the day factor (i.e., the interest accrued per day) over the number of days in a period of time before the next payment date. The principal amount of potentially invested money multiplied by a coupon interest rate equals the amount of interest for a year. The amount of annual interest multiplied by the day factor equals the interest for the period.

The principal amount plus the interest for the period equals the debt service payment to be made from the issuer of eligible securities to the issuer of the escrow or investment being bid. The debt service payment must equal the escrow requirement previously specified in the RFP.

### Price Calculator

During the optimization step, the software can further automatically calculate the price of the OMS, by deriving price if the bidder gives a yield or automatically calculate the yield of the OMS, by deriving yield if the bidder gives a price.

The software can multiply the principal amount and the price together, dividing the result by $100 to determine the cost of the security. The cost of the security can be added to the accrued interest to determine the total cost of the security. Note that the accrued interest equals the amount of interest from issuance date to settlement date. Once the total cost of each security is determined, the total cost of all securities (i.e., the portfolio of securities) can be determined.

From step 220, the process may determine at step 225 whether a sufficient number of bids has been received, according to one exemplary embodiment. For example, federal regulations may require a minimum number of bids to be received to demonstrate that the OMS are offered at a “fair market value.” If only one bid or no bids are received, the RFP can be retransmitted to potential bidders with a new auction end time. According to one example, if the SLGS window is closed, the issuer must be able to demonstrate that it received at least two bids to prove an OMS purchase of “fair market value.” If the SLGS market is open, in this example, the issuer must receive at least three bids.

In this exemplary embodiment, if at least three bids are received, the process moves to step 230, where, once the portfolios of each bid are optimized, the software can determine, which portfolio has the lowest total cost. The bidder with the lowest-cost portfolio wins the bid.

Once a winning bid is determined at step 230, and when the auction closes, the process moves to step 240, where server 120 is configured to publish the auction results by transmitting them to the winning bidder, financial advisor/bidding agent, issuer, and the bond counsel. The software may be configured to require an affirmation from the financial advisor/bidding agent to award the winning bid. According to certain embodiments, the auction results may be published to the public the following day, for example.

From step 240, the process moves to step 250, where the software at server 120 is configured to generate and transmit an initial closing package to the winning bidder at terminal 150, upon affirmation from the financial advisor/bidding agent. Various required forms from the financial advisor/bidding agent, bond counsel, and interested regulatory agencies could be included.

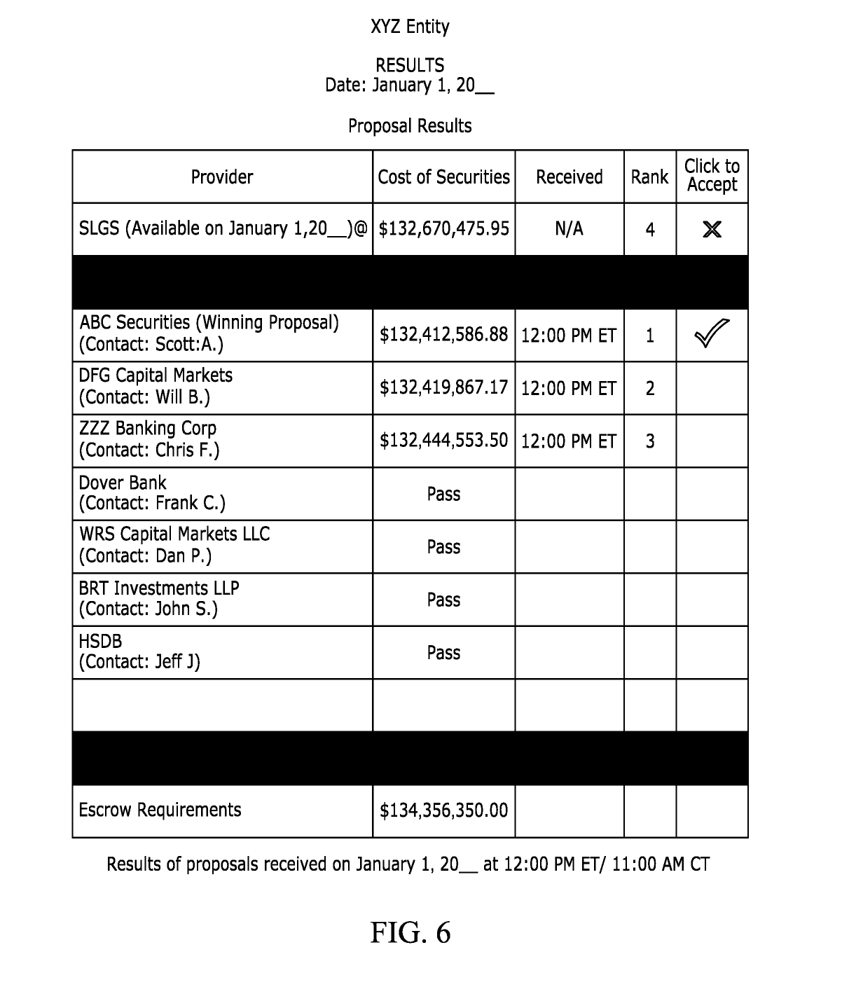

From step 250, the process moves to step 260, where the winning bidder can send a completed closing package, including an executed bid sheet, executed certifications and forms, trade tickets, screen shots, etc. to server 120, which can then be automatically transmitted to issuer terminal 100 (which could include the financial advisor/bidding agent and/or bond counsel, in some embodiments). According to some embodiments, the completed closing package can further include a SLGS comparison, which can be automatically completed by the software at server 120. See, for example, FIG. 6, which shows a screenshot of auction results and a comparison between the optimized cost of OMS and SLGS securities. FIG. 6 also shows where the financial advisor/bidding agent affirmatively accepts the winning bid.

From step 260, the process moves to step 270, where the issuer (e.g., financial advisor, bidding agent, escrow agent, etc.) can upload the escrow account information to server 120.

At step 280, the winning bidder can transmit trade confirmations to the server, for circulation to all parties involved.

At step 290, the software at server 120 can automatically generate invoices to transmit to the winning bidder. The invoices can include the escrow account information financial advisor/bidding agent invoices, invoice for bidding platform usage, wiring instructions, invoice due dates, etc.

At step 300, the winning bidder delivers securities to the escrow account, and pay invoices.

In accordance with present disclosure, on the issuer side, a party or parties may view bids as they are submitted automatically, and there may be multiple simultaneous viewers including the issuer, financial advisor and/or bond counsel. The system can automatically date and time stamp incoming bids received (which is fundamental to demonstration of compliance with “fair market value” determination regulations) and export data into associated software for financial calculations described herein. The system can automatically verify individual securities and their characteristics, verify sufficiency of the portfolio of securities, compare SLGS securities to OMS, and award the bids electronically.

In accordance with the foregoing, security providers (i.e., bidders) are capable of viewing their ranking and bid compared to others, as well as viewing their bids compared to SLGS. An algorithm for calculating escrow sufficiency can be automatically provided to the security providers, along with verification that the bid meets specified and requisite parameters. The present processes provide the ability to sync inventory of eligible securities, with the ability to revise offering with market changes. Further, the disclosure provides one centralized location for upcoming deal calendar(s), and can group and facilitate simultaneous submission of a bid to multiple auctions. The system can have the ability to automatically award the bid and submit all schedules securely through the server 120.

While processes in the figures may show a particular order of operations performed by certain embodiments of the invention, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein and the claims that follow.

What is claimed is:

1. A method of conducting business using competitive bidding and verification of yield restricted escrows and investments, comprising:
automatically transmitting a request for proposal (RFP) from an issuer to at least a predetermined minimum number of potential bidders, wherein the RFP includes
written bid specifications including an amount of money made available to be used to purchase one or more open market securities (OMS), proposal due date, a settlement date, a required cash flow, and an indication of OMS type eligibility; and
automatically transmit to the issuer a plurality of bids from multiple bidders to provide one or more OMS to be purchased using the escrow amount in conformity with the written bid specifications, from at least a predetermined minimum number of bidders.

2. The method of claim 1, wherein the method further includes:
providing each bidder an input module in which each bidder can input information relating to respective sellable OMS for a particular auction;
automatically calculating a cash flow of one or more OMS selected by a bidder based on respective information of each OMS input by the bidder; and
automatically optimizing the total purchase cost of all of the one or more OMS selected by the bidder, based on the respective calculated cash flows and their respective prices.

3. The method of claim 2, wherein automatically optimizing the total purchase cost includes determining a lowest price and amount to sell of the OMS conforming to the written bid specifications.

4. The method of claim 2, wherein the respective information of each OMS includes at least one of a unit price, a number of units and a yield.

5. The method of claim 1, wherein the method further comprising automatically generating an RFP generation screen where the issuer can select one or more eligible OMS types to be automatically incorporated as part of the RFP.

6. The method of claim 1, wherein if a number of the plurality of bids is below a predetermined threshold at a predetermined settlement time, allowing the issuer to execute a re-bid module to automatically re-transmit the RFP to the at least a predetermined minimum number of potential bidders.

7. The method of claim 1, wherein the predetermined minimum number of bidders is at least three when a state and local government series (SLGS) securities window is open, and fewer than three when the SLGS securities window is closed.

8. The method of claim 1, wherein the method further includes automatically indicating to a winning bidder that its bid is selected by the issuing entity.

9. The method of claim 1, wherein the method further comprises automatically indicating to each unsuccessful bidder that its bid was not selected by the issuing entity.

10. The method of claim 8, wherein the method further comprises automatically invoicing a winning bidder, in response to a selection by the issuing entity, a predetermined fee

11. The method of claim 7, wherein the issuer must have proof of soliciting bids from at least three qualified bidders.

12. The method of claim 1, further comprising:
automatically generating an initial closing package; and
automatically transmitting the initial closing package to a winning bidder, wherein
the initial closing package includes requisite certifications and forms for execution.

13. The method of claim 12, further comprising:
automatically generating a complete closing package; and
automatically transmitting the complete closing package to the issuer, wherein
the complete closing package includes at least executed certifications and forms and one or more trade ticket(s).

14. The method of claim 13, wherein the completed closing package includes a comparison between efficiency of the winning bidder's portfolio of OMS in comparison to SLGS securities.

15. A server configured to conduct business using competitive bidding and verification of yield restricted escrows and investments, comprising:
a memory coupled to a processor, wherein the memory stores software, when executed by the processor, configured to:
receive a request for proposal (RFP) from an issuer;
automatically transmit the RFP to at least a predetermined minimum number of potential bidders, wherein the RFP includes
written bid specifications including an amount of money made available to be used to purchase one or more open market securities (OMS), a settlement date, proposal due date, a required cash flow, and an indication of OMS type eligibility;
receive a plurality of bids to provide one or more OMS to be purchased using the escrow amount in conformity with the written bid specifications, from qualifying bidders; and
automatically transmit to the issuer the plurality of bids.

16. The server of claim 15, wherein the software is further configured to:
provide each bidder an input module in which each bidder can input information relating to respective sellable OMS;
automatically calculate a cash flow of one or more OMS selected by a bidder based on respective information of each OMS input by the bidder;
automatically optimizing the total purchase cost of all of the one or more OMS selected by the bidder, based on the respective calculated cash flows and their respective prices.
